(19) United States
(12) Patent Application Publication
(10) Pub. No.: US 2022/0221602 A1
(43) Pub. Date: Jul. 14, 2022

(54) SYSTEM FOR ACQUIRING SEISMIC DATA

(71) Applicant: EQUINOR ENERGY AS, Stavanger (NO)

(72) Inventor: Kjetil JOHANNESSEN, (US)

(21) Appl. No.: 17/609,620

(22) PCT Filed: May 19, 2020
(86) PCT No.: PCT/NO2020/050129

§ 371 Date: Nov. 8, 2021

(30) Foreign Application Priority Data
May 22, 2019 (GB) 1907219.8

(51) Int. Cl. G01V 1/22; G01D 5/353; G01V 1/38; G01V 1/20

(52) U.S. Cl. CPC G01V 1/226; G01D 5/35361; G01V 1/20; G01V 1/3808; G01D 5/35374

(57) ABSTRACT

A distributed acoustic sensing system for acquiring seismic data is presented. The system includes a sensing cable and an instrument float. The sensing cable is for sensing seismic waves and is suitable for use on the seabed. The instrument float includes instrumentation for acquiring seismic data. The instrument float is connectable or connected to the sensing cable via a riser cable.

The present invention relates to the field of seismic data acquisition. In particular, it relates for a system for acquiring seismic data for use in a seabed location.

It is known to use seabed seismic data acquisition systems to obtain seismic data related to a geological structure beneath the seabed. Such seabed systems have the advantage, compared with sea surface level systems, that there are fewer reflections in the seismic data which would require cancelling, so clearer data can be obtained. In addition, seabed systems allow for a greater variety of measurements to be made (e.g. s-wave measurements) compared with sea-level systems. However, known seabed systems are expensive and time-consuming to install.

The present invention seeks to provide an improved seabed seismic data acquisition system, which may be cheaper than existing systems and may be deployed and optionally also recovered quickly.

According to a first aspect of the invention, there is provided a distributed acoustic sensing system for acquiring seismic data, the system comprising:
a. a sensing cable for sensing seismic waves, the sensing cable being suitable for use on the seabed; and
b. an instrument floating structure comprising at least some instrumentation for use in the acquisition of seismic data, the instrument floating structure being connectable or connected to the sensing cable via a riser cable.

In use, the sensing cable can be, and preferably is, located on the seabed. Thus, a system is provided which is suitable for sensing seismic data on a seabed location. As discussed above, measuring seismic data on the seabed, as opposed to at a sea level location, means that there are fewer reflections in the seismic data which would require cancelling so clearer data can be obtained.

The sensing cable may be any cable suitable for sensing seismic waves.

The sensing cable is preferably a fibre optic sensing cable, e.g. a sensing cable comprising a fibre optic (glass fibre) part.

The sensing cable is preferably provided in the form of a (e.g. single) continuous unbranched cable, e.g. without any further fibre optic cables branching from it. In other words, the system preferably comprises a continuous unbranched fibre optic sensing cable. This can provide a simpler system compared to systems with branched sensing cables or nodes, which can be easier to deploy and/or retrieve. In addition, the absence of nodes in the sensing cable can be advantageous in terms of data quality.

The sensing cable preferably comprises: a sensing part (e.g. a sensing middle or central part) and one or more (preferably at least two) protective layers arranged, preferably concentrically, around the sensing part.

The sensing part preferably comprises one or more glass fibres and, more preferably, (only) a single glass fibre, i.e. a single glass fibre strand. This can help to keep the sensing cable cheap and easy to deploy.

The sensing part may have a diameter of around 125 μm.

The one or more protective layers are preferably arranged, e.g. concentrically around the sensing part, to protect the sensing part from water ingress and/or mechanical damage, at least for a particular period of time. For example, the one or more protective layers may be chosen or designed such that they can prevent water ingress (e.g. when located in a seabed location) for a period of between (or at least) one day and one week, for example. This may provide sufficient time for a seismic survey to be performed.

The one or more protective layers may be made of one or more (protective) materials such as silicone, polyurethane, high density polyethylene and/or high density polypropylene. These are materials with reasonably good resistance to water penetration in low temperature conditions (as long as they are mechanical intact).

In some embodiments, the one or more protective layers may comprise two or more layers of different (or at least two different) materials (e.g. such as those mentioned above). Layering different materials in this way may help to prevent any flaw in a layer from penetrating all the way to the sensing part.

In some embodiments, the one or more protective layers may comprise a metal layer. This can provide further protection. However, it is not essential and preferably, the one or more protective layers do not comprise a metal layer.

The one or more protective layers preferably comprise an inner protective layer and an outer protective layer, wherein the inner protective layer is arranged between the sensing part and the outer protective layer. The inner protective layer may be an innermost protective layer, for example. The outer protective layer may be an outermost protective layer, for example. In some embodiments, the one or more protective layers comprise only the inner and outer protective layers. In other embodiments, one or more further protective layers are provided.

The inner protective layer preferably has a lower elastic modulus than the sensing part. This can help to protect the sensing part from mechanical stresses by transferring any compressive forces acting on the sensing cable (e.g. including hydrostatic pressure) into a linear strain along the cable length.

The/a (e.g. inner) protective layer preferably adheres or is adhered to the sensing part. The adhesion to the sensing part may be facilitated, for example, by the provision of a priming layer applied between or onto the sensing part or protective layer which is adhered to it.

In a preferred embodiment, the one or more protective layers comprise a silicone layer and, preferably, the inner protective layer is a silicone layer. However, other polymers could be used. All polymers have a much lower Young's (elastic) modulus than glass, particularly rubber-type substances. However, as well as having a lower Young's modulus than the sensing part, the protective layer (e.g. the layer adjacent the sensing part) preferably also has good adhesion to the sensing part, possibly with the use of a priming layer, e.g. if needed. Silicone in particular can provide good adhesion to the sensing part and a low elastic modulus.

The outer protective layer preferably has a greater tensile strength and/or weight and/or density than the sensing part and/or inner protective layer.

The outer protective layer may be made of a plastics material such as high density polypropylene and/or high density polyethylene, for example In some embodiments, the material from which the outer protective layer is formed may comprise a substance (e.g. a strengthening substance) and/or armouring fibres, provided, preferably, that the substance and/or armouring fibres still provide an outer protective layer which is waterproof or water-resistant, at least for a preferred period of time. Forming the outer protective layer from a material such as a plastics material such as high density polypropylene and/or high density polyethylene can provide a hard, water-resistant outer coating of the sensing cable. It can also add weight to the sensing cable and provide an increased tensile strength.

As described above, in some embodiments, fibres may be included in the outer protective layer. For example, aramid (Kevlar), structured polyethylene and/or metal fibres may be included in the outer protective layer. The provision of such fibres may help to provide increased tensile strength and increased weight.

In some embodiments, the one or more protective layers (e.g. one or more of the one or more protective layers) may be biodegradable. For example, the one or more protective layers could comprise natural rubber and/or cellulose fibres. As such, if the sensing cable is not retrieved from the seabed (e.g. it is not possible to or if it, or a part of it, breaks from the rest of system) then the one or more protective layers may biodegrade, leaving only, for example, a glass fibre part (which is made of the same material as sand). In some embodiments, the (or at least one of) the one or more protective layers may be arranged to biodegrade or decompose when underwater for longer than one day or one week.

The one or more protective layers, or an outer protective layer, are (is) preferably made of a material which is not attractive to marine creatures, i.e. it is preferable that marine creatures, such as fish, would not be attracted to eat (e.g. part of) the one or more protective layers or an outer protective layer.

The one or more protective layers (e.g. one or more of the one or more protective layers) are preferably inhomogeneous, i.e. form(s) an inhomogeneous structure. This can mean that the structure of the cable as a whole has a low overall bulk modulus and/or a high Poisson ratio.

One or more of the one or more protective layers may be made of a material comprising fibres or a woven material (e.g. Kevlar). In such cases, at least some of the fibres are arranged (e.g. spun/woven) at an angle to the longitudinal axis of the cable (i.e. they are not collinear with the longitudinal axis of the cable). Generally, the greater the angle between the fibres (e.g. their weave pattern) and the longitudinal axis of the cable, the greater the compressive force transferred as longitudinal stress to the sensing part. Thus, greater angles between at least some of the fibres (e.g. their weave pattern) and the longitudinal axis of the cable may be preferred. In many sensor applications (such as the present invention), a preferential orientation of (armouring) fibres is collinear with the longitudinal axis of the cable. The pattern of the armouring material (fibres), e.g. fibre orientation, spinning/weaving pattern/orientation, may be used to form an effective low elastic modulus material while still maintaining mechanical protection of the optical fibre (sensing part) within the cable. The fibres (or at least some of the fibres or their weave pattern) may be arranged such that their angle to the longitudinal axis of the cable is such that the bulk elastic modulus of the sensing part matches that of (at least some of) the protective layer(s) comprising fibres. However, it can be advantageous to provide the protective layer(s) with some (e.g. inner) fibres arranged at a (relatively) high(er) angle to the longitudinal axis of the cable, and some (e.g. outer) fibres arranged at a (relatively) low(er) angle to the longitudinal axis of the cable. Such an arrangement where some (e.g. outer) fibres are arranged at a (relatively) low(er) angle to the longitudinal axis of the cable can provide a sensing cable with increased breaking strength (i.e. a greater longitudinal force is required to act on the cable in order to break it).

The sensing cable preferably has sufficient density that it will sink down to a seabed. The density of the sensing cable is preferably greater than the density of water or sea water.

The total diameter of the sensing cable may be around 1.5-4 mm.

Preferably, the sensing cable is flexible or at least sufficiently flexible that it can be arranged, for example, in a curved pattern on the seabed, e.g. covering a geological structure to be surveyed.

The sensing cable may have a total length of around 10-30 km, for example. In some embodiments, the sensing cable may have a length of up to around 50 km or even more, e.g. with technological advances in sensing cables. Excess length in a far end of the cable (e.g. a first end as described below) could be used, for example, to simplify the laying out or installing of the cable on the seabed. Measurements are single ended and additional length can help to reduce end reflections.

The sensing cable may have a first end and a second end.

The first end of the sensing cable is preferably free and/or movable, i.e. not directly attached to any other (e.g. fixed or relatively fixed) component.

The first end may comprise a device or means for reducing end reflection (i.e. reflection from the end of the sensing cable) at the first end of the cable. The device or means for reducing end reflection is preferably formed and/or attached to the first end of the cable just before the cable is installed, e.g. on a vessel from which the cable is deployed (e.g. as described below).

The device or means for reducing end reflection may comprise any known means for reducing end reflection. For example, the device or means for reducing end reflection could comprise a crushed or otherwise deformed region of sensing cable, particularly the sensing part. In another example, the device or means for reducing end reflection could comprise a coiled region (e.g. around 1 cm in diameter) of sensing fibre (sensing part). In a further example, reflection may be reduced by providing a fluid or gel with a matching refractive index to that of the sensing part (fibre) surrounding the sensing part (fibre) end.

The first end may (additionally or alternatively to the device or means for reducing end reflection) comprise a cap at the first end of the cable. The cap is preferably arranged to prevent water from entering the sensing cable, e.g. at its first end. Any kind of (e.g. known) waterproof, sealing cap could be used for this purpose. Similarly to the device or means for reducing end reflection, the cap is (also) preferably made and/or attached to the first end of the cable just before the cable is installed, e.g. on a vessel from which the cable is deployed (e.g. as described below).

The device or means for reducing end reflection and/or the cap may thus be customised or adapted for the particular seismic survey which is to be performed and/or to the location in which the survey is to be performed.

The sensing cable (e.g. and preferably its second end) may be connected, e.g. via the riser cable, to the instrument floating structure.

As discussed above, an instrument floating structure is also provided. An instrument floating structure may be any kind of float or floating or buoyant body suitable for containing or carrying instrumentation for acquiring seismic data. In some embodiments, the instrument floating structure may be provided in the form of a vessel (boat). In other cases, the instrument float may be considerably smaller than a typical vessel (boat) and may, for example, simply provide a float or buoyant platform or container on/in which instrumentation for acquiring seismic data may be provided.

The instrument floating structure comprises (at least some) instrumentation for use in the acquisition of seismic data (e.g. as discussed below) and is connectable or connected to the sensing cable via a riser cable. The instrument floating structure need not necessarily comprise all of the instrumentation required for acquiring seismic data. Some instrumentation for acquiring seismic data could, for example, be provided elsewhere, e.g. in a submerged or underwater location (in use).

The riser cable is preferably arranged to allow signals such as optical signals, e.g. representing seismic waves and/or pulses, detected by the sensing cable to be transmitted from the sensing cable to the instrument floating structure (or more particularly its instrumentation).

The riser cable thus preferably comprises (or is formed of) a signal-transmitting cable, such as a fibre optic cable. Any cable suitable for transmitting optical signals underwater can be used. For example, the signal-transmitting cable preferably comprises a waterproof coating. The riser cable could be a conventional subsea cable with the signal-transmitting (e.g. fibre optic) cable provided in an outer casing such as an hermetic metal tube.

The riser cable may comprise a mooring part or mooring cable such as a rope or chain. Thus, in some embodiments, a signal-transmitting cable and a mooring part or cable may be provided in (or in the form of) a single cable. For example, the signal-transmitting cable could be threaded through a mooring part or cable (e.g. inside an outer casing). In another embodiment, the signal-transmitting cable could be attached to (e.g. threaded through apertures provided on or otherwise connected to) the mooring part or cable, e.g. at a plurality of locations along a length of the mooring part or cable.

Alternatively, a mooring part or cable (e.g. for the instrument floating structure) may be provided separately to (e.g. not attached or connected to) the signal-transmitting cable.

In either case, the mooring part or cable is preferably stronger than the signal-transmitting cable.

In use, the mooring part or cable is preferably arranged such that it experiences a greater load or strain than the signal-transmitting cable, i.e. it preferably is arranged to prevent the signal-transmitting cable from experiencing any potentially damaging loads or strains.

In some embodiments, the mooring part or cable is longer than the signal-transmitting cable. The extra length of the mooring part or cable may be provided in the form of a so-called “pig-tail”. The signal-transmitting cable may be a single-use cable but the mooring part or cable may be suitable for multiple uses (e.g. seismic surveys). As such, the mooring part of cable may be cut (spliced) after use to detach it from the signal-transmitting cable, and the extra length (or some of the extra length) can then be used in a subsequent seismic survey.

The riser cable (with or without the mooring part or cable) is preferably stronger than the sensing cable. This is because, when in use, it has to withstand greater forces, e.g. tensile forces, than the sensing cable, which is arranged on the seabed.

The instrument floating structure is preferably connected to a first anchor or anchoring means, e.g. via the riser cable (e.g. and preferably its mooring part or cable) or a separate mooring part or cable.

The sensing cable is preferably connected to at least one anchor or anchoring means, and preferably to (at least) the same (first) anchor or anchoring means to which the instrument floating structure is connected.

Thus, the first anchor is preferably arranged to keep the instrument floating structure and/or sensing cable in a relatively fixed position. Of course, a small amount of movement due to currents, for example, may be inevitable but this is preferably minimised through use of the first anchor (at least). Any suitable anchor may be used as the first anchor. This may, for example, depend on the nature of the sea bed in a particular installation or survey location.

A connector may be provided on the (first) anchor for connecting the riser cable (e.g. its mooring part or cable) or a separate mooring part or cable to the anchor. In some embodiments, this connector may also be used to connect the sensing cable to the (first) anchor. In alternative embodiments, a further connector could be provided to connect the sensing cable to the (first) anchor.

The connector is preferably arranged such that the riser cable (e.g. its mooring part or cable) or a separate mooring part or cable, and/or the sensing cable, can be connected to the anchor in a movable/slidable manner. In other words, preferably, the riser cable (e.g. its mooring part or cable) or a separate mooring part or cable, and/or the sensing cable can preferably still move, e.g. slide longitudinally, with respect to the anchor whilst being held at or close to the anchor by the connector.

For example, the connector may comprise a guide or guiding part, e.g. in the form of one or more loops, channels or apertures through which the riser cable (e.g. its mooring part or cable) or a separate mooring part or cable, and/or the sensing cable may be threaded, thereby allowing the riser cable (e.g. its mooring part or cable) or a separate mooring part or cable, and/or the sensing cable to move longitudinally with respect to the anchor whilst still being connected to it.

The connector preferably comprises rounded and/or smooth edges, e.g. with no sharp edges, such that preferably it will not cause damage to a sensing cable connected to it. For similar reasons, the connector may be formed of a relatively soft material such as rubber or a rubbery material.

As discussed above, the instrument floating structure comprises (at least some) instrumentation for performing a seismic survey or acquiring seismic data. For example, the instrumentation may comprise one or more of an interrogation unit, a (e.g. GPS) antenna, a radio connection (receiver/transmitter) to a vessel, a battery (or batteries) and/or a DAS control system with a hard drive or memory.

Preferably, the instrumentation comprises at least a receiver and/or antenna (e.g. a radio receiver and/or GPS antenna), as it is desirable that this/these components should be provided in a location above the surface of the sea. However, an (the) interrogation unit, for example, could be provided in an alternative location, such as a submerged location beneath the surface of the sea. If any part of the instrumentation (e.g. the interrogation unit) is not provided in the instrumentation on/in/at the instrument floating structure, then it should still be connected (directly or indirectly) to the sensing cable.

The instrument floating structure may comprise buoyancy means, such as one or more air-filled compartments or vacuums, e.g. for keeping the instrument floating structure (with the instrumentation) afloat.

A (e.g. GPS) antenna may provide a clock reference (time) signal for the DAS control system. It may also be used to verify that the mooring system is holding/secure.

The battery(ies) preferably provide sufficient power for the DAS control system for one seismic survey or about one day. Other sources of power could of course additionally or alternatively be used.

The DAS control system is preferably arranged to be remotely controlled by the (a) seismic survey vessel while locally recording data received from (or representing signals received from) the sensing cable in memory (or hard drive/solid state drive arrays).

The interrogation unit comprises a distributed acoustic sensing interrogator which is preferably arranged to send out optical pulses and decode the phase of received Rayleigh backscatter, converting it to a distribution of instantaneous strain rate along the fibre (sensing part) or sensing cable, which in turn is sensitive to acoustic pressure changes (or hydrostatic pressure changes).

The interrogation unit may comprise one or more remote control features (i.e. features which may be controlled remotely), such as a battery saving means for battery saving, and a pulse repetition frequency adjusting means for adjusting a pulse repetition frequency, e.g. on demand.

The interrogation unit may be a standard interrogation unit such as one which is currently known in the art.

The instrumentation may comprise a receiver such as a radio signal receiver for receiving a signal to begin a seismic survey. For example, the receiver may be arranged to receive a radio signal, e.g. from a (seismic survey) vessel, instructing the DAS control system or instrumentation to begin a seismic survey. Such a radio connection may primarily be used to save battery and recording medium, e.g. by receiving a signal to turn off recording when a seismic survey vessel is not shooting (emitting seismic waves/pulses), i.e. performing a seismic survey.

The instrument floating structure is preferably designed, adapted or arranged such that it will float on the sea surface.

In a preferred embodiment, the system further comprises one or more buoys. The one or more buoys may be connected to the sensing cable via one or more connection means (e.g. connecting members), such as ropes, cords or chains.

The one or more connection means and/or the sensing cable are preferably each attached to a (further) anchor or anchoring means. The (further) anchor or anchoring means may (each) comprise one or more connectors (e.g. such as the connector described above in relation to the first anchor or anchoring means) for connecting the one or more connection means and/or the sensing cable to the further anchor or anchoring means, e.g. in a movable/slidable manner.

Any suitable anchor(s) could be used, e.g. depending on the nature of the sea bed at the installation/survey location.

The connection means preferably provide(s) simple mechanical attachment between the buoy(s) and the sensing cable and/or anchor(s). They do not need to transmit any signals so any kind of mechanical attachment such as rope, cord or chain suitable for such connection may be used.

In some embodiments, (e.g. where a geological structure to be surveyed is particularly large and cannot be covered, for example, by a single sensing cable), two or more sensing cables may be provided.

In some embodiments, the two or more sensing cables (e.g. as described above) may each be provided in a system corresponding to the system described above, such that each sensing cable is connected to a separate (its own) instrument floating structure.

In other embodiments, multiple (two or more) sensing cables (e.g. as described above) may be connected to a common or shared instrument floating structure (e.g. each via their own “riser cable” such as described above). In such a case, the common or shared instrument floating structure may comprise separate instrumentation (a separate instrumentation unit), or some separate instrumentation, for each sensing cable which is connected to the common or shared instrument floating structure. Alternatively, the multiple sensing cables may be connected (e.g. multiplexed) to a single instrumentation unit in the common or shared instrument floating structure.

By providing a distributed acoustic sensing system with a sensing cable and an instrument floating structure as described above, a simple, cheap, single-use and easily deployable and recoverable system can be provided for acquiring seismic data in a seabed location.

As the sensing cable, or the distributed acoustic sensing system, is preferably, at least partially, a disposable or single-use system, the sensing cable need not necessarily be as well protected as sensing cables designed for use in systems which are not disposable or single-use and would thus need a longer lifetime. The sensing cable of the present system, at least in some embodiments, need only last (i.e. protect the sensing part e.g. from water ingress or stresses or strains) for the duration of a seismic survey, e.g. for one day. Thus, as the sensing cable need not necessarily be as well protected as other sensing cables, it can have thinner protective layer(s) than other sensing cables, which can lead to the sensing cable having a better or greater sensitivity to hydrostatic pressure, and being able to provide more accurate measurements. For example, most known subsea cables currently in use essentially have an optical fibre provided in a pressure vault. Such cables still detect (are sensitive to) an acoustic signal but are shielded to some extent from the direct pressure. On the other hand, the present invention, at least in its preferred embodiments, may have its sensing part (core) at hydrostatic pressure.

When deployed and ready for use, the sensing cable(s) and any anchors are preferably located on a seabed. The instrument floating structure(s) and any buoys are preferably located on a sea surface. The sensing cable(s) is(are) preferably arranged over an area such as a (known or unknown) geological structure to be surveyed (e.g. about which it is desired to obtain seismic data).

According to a further aspect, there is provided a method of deploying a distributed acoustic sensing system for acquiring seismic data, the system preferably being as described above (e.g. with any of the optional or preferred features), the method comprising:
a. deploying a sensing cable from a vessel; and
b. connecting an instrument floating structure via a riser cable to the sensing cable.

The system is preferably deployed such that the sensing cable is arranged on a sea bed and over a geological structure to be surveyed.

One or more buoys may be connected to the sensing cable as the sensing cable is deployed.

In order to deploy or install the system, a vessel may bring the system to an area (an area of interest) in which it is intended to be installed (e.g. above a geological structure to be surveyed).

When the vessel is located above (or close to above) the area, the sensing cable may be deployed or spooled out, starting with a first, free end, for example. As the sensing cable is spooled out, the sensing cable is preferably arranged such that it sinks down to the seabed.

The sensing cable is preferably deployed or spooled out or installed such that it lies over the area (e.g. the geological structure) for example in a (roughly) predetermined pattern or arrangement. The sensing cable may curve around such that the geological structure is covered substantially evenly with the sensing cable. The positioning of the sensing cable does not necessarily have to be particularly accurate (e.g. its actual positioning may be determined later) but it is desirable that good overall (even) coverage of the geological structure should be provided.

The first end of the sensing cable is preferably spooled out or installed such that it lies just outside of the area of interest (outside of an area over the geological structure to be surveyed). This bit of excess length of sensing cable (i.e. the part of the sensing cable lying outside of the area of interest) may allow the sensing cable (the rest of the sensing cable) to be oriented in a correct or desirable direction for the rest of the spooling operation.

The second end of the sensing cable is preferably spooled out or installed such that it is located in a relatively central location over the geological structure or area of interest, or over a most important area to survey. This can help to provide the best signal-to-noise ratio for the most important area.

The sensing cable is preferably spooled out or installed in such a way that interference (e.g. between a main signal and a spurious signal) is minimised or avoided. For example, the sensing cable is preferably arranged, e.g. on a sea bed, in such a way that points along the sensing cable whose received signals may interfere with each other (e.g. points of nearest neighbour signals) are not located adjacent or close to each other but are preferably spaced apart. Points along the sensing cable whose signals may interfere with each other may have a separation distance between them along a longitudinal length of the sensing cable, wherein the separation distance may be determined, for example, from a pulse repetition frequency, e.g. of an interrogator in the instrumentation.

Any buoys and the instrument floating structure (e.g. with any associated anchors) may be connected to the sensing cable, for example via the connection means or cable, as the sensing cable is spooled out.

The sensing cable is preferably spooled out of installed in such a way that it is easily recoverable, or facilitates its recovery. For example, any buoys and the instrument floating structure may be arranged such that they are relatively close together thereby reducing or minimising a distance that a recovery vessel would have to travel over in order to collect up the system via the buoys and instrument floating structure.

When the sensing cable has been spooled out and is connected to any buoys and the instrument floating structure, the vessel is preferably disconnected from or no longer connected to the system, and is free to move around the sea surface.

The method preferably further comprises determining the position of the deployed sensing cable.

Once the system has been deployed, e.g. as described above, before a seismic survey can be performed, the position of the sensing cable is preferably determined. This may be done, for example, using a standard technique such as emitting a seismic wave from a seismic source (e.g. located on or attached to a/the vessel), measuring a first direct arrival and triangulating the first direct arrival for multiple shot directions.

The steps of synchronising the seismic source and varying the instrument floating structure repetition frequency may be performed. Such steps may allow for “tricks” to be performed when only timing the first arrival, thereby effectively allowing the upper frequency limit of the instrumentation with a long cable to be circumvented for positioning purposes. If a spurious signal of a direct arrival from an area of little interest arrives, it can essentially be subtracted from a total response to leave the main or wanted response after being identified at a lower pulse repetition frequency of the laser. Shifting the timing essentially shifts the position of the spurious signals, so e.g. a timing can be done so that the high frequency shallow seismic survey can be performed at a higher upper frequency than the total length of the cable would otherwise dictate. The rule of thumb in DAS surveys is to only use a pulse repetition rate as low as the total roundtrip time for the optical signal in the fibre. This would be a trick to not have to reposition the seabed array to achieve also a high frequency survey close to the seismic source, particularly in shallower water.

Such a method as described above can allow the position of the sensing cable to be determined with a resolution of approximately 1-2 m of cable length, which is substantially better than most existing systems.

According to a further aspect, there is provided a method of acquiring seismic data related to a subsea geological structure, the method comprising using a distributed acoustic sensing system as described above (comprising any of the optional or preferred features), the method comprising:

a. emitting seismic waves and/or pulses from a seismic source; and

b. detecting reflected seismic waves and/or pulses with the sensing cable.

The reflected seismic waves and/or pulses are preferably reflected from a geological structure (e.g. one or more reflector surfaces in the geological structure) about which it is intended to obtain seismic data.

The seismic source may be any seismic source suitable for performing a seismic survey, e.g. as is known in the field. One or more seismic sources may be used.

The seismic source may be provided on or attached to a vessel. This could be the same vessel that was used to deploy the system, or it could be a different vessel.

To perform the seismic survey, a vessel with the seismic source preferably travels around, e.g. criss-crossing, over the geological structure and source array (e.g. as providing by the sensing cable), emitting seismic waves and/or pulses from the seismic source (e.g. in a standard way as is known in the art).

The method preferably further comprises recording seismic data representing the detected seismic waves and/or pulses e.g. with or at the instrument floating structure or its instrumentation. For example, seismic data collected during the survey may be stored in a memory, which is preferably provided on/at/in the instrument floating structure (e.g. in its instrumentation). After the survey has been performed, the/a vessel may collect the memory, e.g. from the floating structure, and take it for further storage, processing and/or analysis.

The seismic source and the instrument floating structure electronics (instrumentation) are preferably synchronised using a recorded GPS clock signal and are preferably time shifted in the seismic processing.

In a preferred embodiment, the method may comprise receiving a signal at the instrument floating structure (e.g. at its instrumentation), the signal comprising instructions to start a seismic survey. For example, a seismic survey may be initiated by sending a signal (e.g. a radio signal) from a vessel (e.g. with a seismic source) to the instrument floating structure (e.g. to its instrumentation), signalling to start a seismic survey. On receipt of this signal, a battery on the instrument floating structure (e.g. in its instrumentation) may power the (other) instrumentation on the floating structure to record signals sensed in the sensing cable, e.g. by a distributed measurement system provided on the instrument floating structure.

Once a survey has been performed, the system may be recovered e.g. as described below. In some cases, the sensing cable or part(s) of the sensing cable may not be recovered. In some cases, on the instrument floating structure and/or any buoys may be recovered.

Thus, according to a further aspect, there is provided a method of recovering a distributed acoustic sensing system such as described above (e.g. with any of the optional or preferred features), the method comprising gathering or retrieving the instrument floating structure and/or one or more buoys connected to the sensing cable via one or more connection means.

If any instrumentation (e.g. the interrogation unit) is provided in one or more further or separate locations to the instrument floating structure, then that instrumentation (or at least some of it, e.g. and in particular the interrogation unit) is preferably also recovered, e.g. by gathering or retrieving it.

In some embodiments, the whole sensing cable, and optionally also the riser cable, may be disconnected from the rest of the system and, for example, left in the sea. Use of biodegradable protective layers may be useful in such cases. In such cases, the instrument floating structure and/or buoys are preferably still collected, optionally with any anchors, connection means and/or the riser cable (if this has not been disconnected and left in the sea).

In other embodiments, the sensing cable may be retrieved, e.g. by spooling it back in (for example in the opposite way to which was deployed initially, and possibly using the same spooling means). The retrieved sensing cable may be taken away for appropriate disposal. If the sensing cable snaps or breaks during retrieval, then any broken-off part(s) of the sensing cable, which it is then for example not possible to spool in or retrieve, may be left in the sea (e.g. to biodegrade, if possible).

In other embodiments, the instrument floating structure and any buoy(s) could be used to retrieve the sensing cable, for example by gathering up the instrument floating structure and any buoys (which are themselves preferably connected to the sensing cable via the cable and connection means). This may be done in a similar way to which crab pods on a line are retrieved. For example, the sensing cable may be pulled in by gathering/pulling in the instrument floating structure and (preferably) any buoys.

In other embodiments, the instrument floating structure and any buoy(s) could be retrieved with a trawl gate system. In such a system, a trawl gate may be connected to a vessel, e.g. with cables, preferably via a grapping device. An underwater slack line may allow the instrument floating structure and any buoys (and the sensing cable to which they are connected) to be captured in the grappling device.

Viewed from a further aspect, there is provided a sensing cable suitable for use in a distributed acoustic sensing system for acquiring seismic data such as described above (e.g. with any of the optional or preferred features), the sensing cable comprising:
a. a sensing part; and
b. one or more protective layers arranged around the sensing part.

The sensing cable may have any of the optional or preferred features of the sensing cable described above.

Embodiments of the present invention can provide a system in which a seismic receiver can be deployed to and recovered from the seabed rapidly. The system may also have better sensitivity and less directionality issues compared to systems using traditional seabed cables.

Preferred embodiments of the invention will now be described with reference to the accompanying figures, in which:

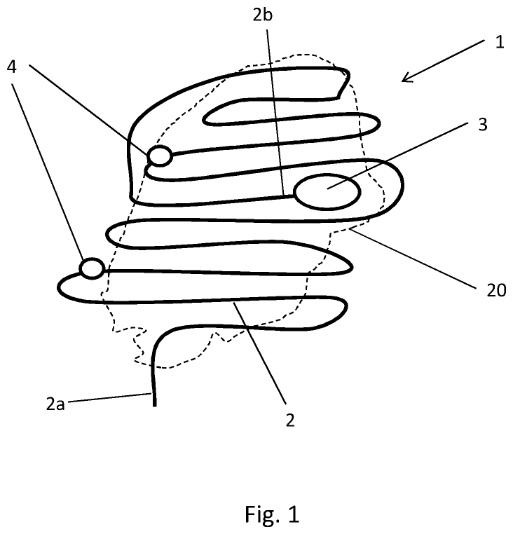

FIG. 1 is a schematic plan view of a distributed acoustic sensing system according to an embodiment;

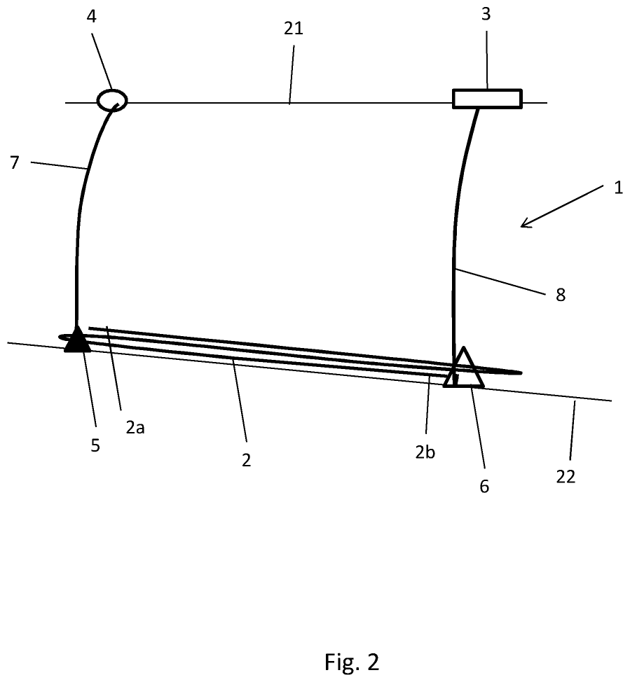

FIG. 2 is a schematic side view of the distributed acoustic sensing system of FIG. 1;

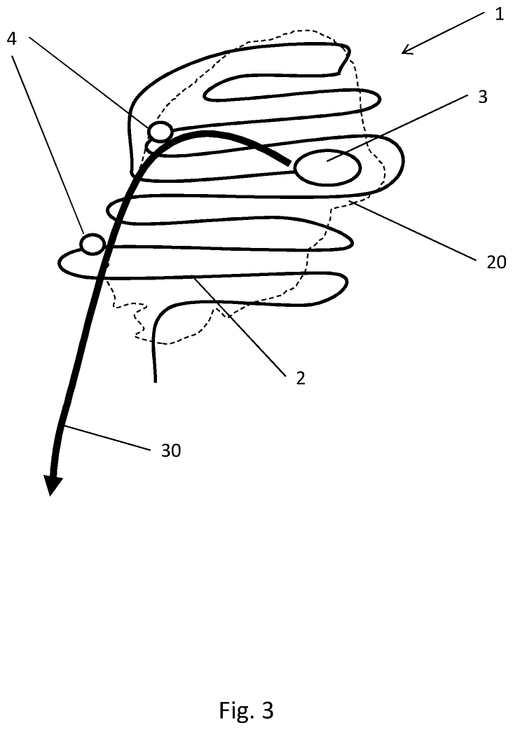

FIG. 3 is the schematic plan view of the distributed acoustic sensing system of FIG. 1 illustrating a method of recovery;

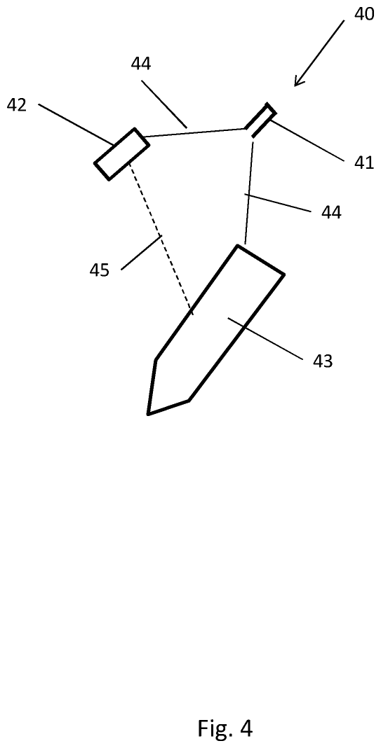

FIG. 4 is a further schematic plan view illustrating a method of recovery of the distributed acoustic sensing system of FIG. 1; and

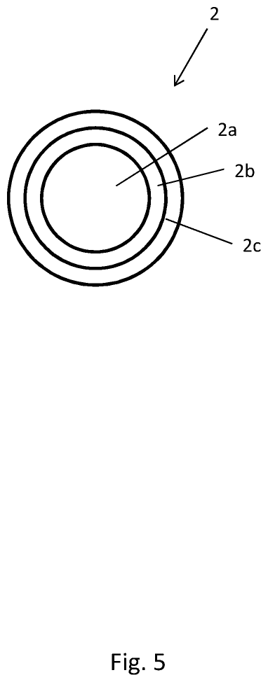

FIG. 5 is a schematic cross-sectional view of a cable for use in the distributed acoustic sensing system of FIG. 1.

FIGS. 1 and 2 illustrate a distributed acoustic sensing (DAS) system 1 for acquiring seismic data and for use on a seabed 22.

The DAS system 1 comprises a sensing cable 2, an instrument float 3 with associated main anchor 6, and buoys 4 with corresponding anchors 5.

The instrument float 3 is attached to the sensing cable 2 and main anchor 6 via a riser cable 8. The buoys 4 are attached to the sensing cable 2 and anchors 5 via ropes or cords 7.

FIGS. 1 and 2 illustrate the system 1 deployed and ready for use. In such a situation, the sensing cable 2 and anchors 5 and 6 are located on the seabed 22. The instrument float 3 and the buoys 4 are located on the sea surface 21. The sensing cable 2 is arranged over a geological structure 20 (the outline of which is indicated with the dashed line) to be surveyed.

FIG. 5 is a cross-sectional schematic illustration of the sensing cable 2. This figure is not to scale and merely illustrates the relative positions of the different layers or parts of the cable. However, the different layers or parts of the sensing cable 2 may have different (e.g. different relative) thicknesses than those shown. As illustrated in FIG. 5, the sensing cable 2 is formed of a glass fibre 2a, an intermediate layer 2b and an outer layer 2c.

The glass fibre 2a has a diameter of around 125 μm and is formed of a single glass fibre strand. The optical signal is guided in a core of the fibre 2a. which typically has a diameter of around 10 μm.

The intermediate and outer layers 2b, 2c protect the glass fibre 2a from water ingress and mechanical damage.

The intermediate layer 2b is formed of silicone. This has good adhesion to the glass fibre 2a and a low elastic modulus. The low elastic modulus helps to transfer any compressive forces acting on the sensing cable 2 into a linear strain along the fibre length.

The intermediate layer 2b has a thickness of around 600 μm.

In some embodiments, a biodegradable intermediate layer 2b is used.

The outer layer 2c is made of high density polypropylene or high density polyethylene. This forms a hard, water-resistant outer coating of the sensing cable 2. It also adds weight to the sensing cable 2 and provides an increased tensile strength.

The outer layer 2c has a thickness of around 1.5 mm-4 mm.

In some embodiments (not shown), two or more outer layers, e.g. of high density polypropylene or high density polyethylene, are used.

In some embodiments, fibres, such as natural rubber or cellulose fibres, are included in the outer layer 2c to provide an increased tensile strength.

In some embodiments, a biodegradable outer layer 2c is used, such as described above.

In any embodiment, the outer layer 2c (and intermediate layer 2b) should delay water penetration to the glass fibre 2a by around one week. This should provide sufficient time for a seismic survey to be performed.

The total diameter of the sensing cable 2 is around 1.5 mm-4 mm. The sensing cable 2 should have sufficient weight or density to be deployable (i.e. to sink down to the seabed 22) and the intermediate and/or outer layer(s) 2b, 2c must provide water protection for the glass fibre 2a. However, the sensing cable 2 should also ideally have the minimum thickness of intermediate and/or outer layer(s) 2b, 2c needed to achieve these objectives, in order to reduce the about of material to be disposed of after use.

The sensing cable 2 typically has a total length of around 10-30 or 40 km. However, in some embodiments, the sensing cable 2 could have a length of more than 40 km, e.g. up to 50 km or more. The actual physical length can be even longer, but the active sensing length of the sensing cable 2, with existing technology, is typically limited to the order of 40 km or less, dependent on the type of interrogator technology used. In the future, developments in the interrogator and/or sensing cable technology may allow even longer lengths of (active) sensing cable 2 to be used, such as up to 50 km or more.

The sensing cable 2 has a first, free end 2a and a second end 2b. The second end 2b is connected, via riser cable 8 to the instrument float 3.

The instrument float 3 comprises the instrumentation for performing a seismic survey. It comprises an interrogation unit, a GPS antenna, a battery and a DAS control system with a hard drive or memory.

The interrogation unit contains a distributed acoustic sensing interrogator which is arranged to send out optical pulses and decode the phase of received Rayleigh backscatter, converting it to a distribution of instantaneous strain rate along the fibre, which in turn is sensitive to acoustic pressure changes (or hydrostatic pressure changes).

The GPS antenna provides a clock reference signal for the DAS control system.

The battery provides sufficient power for the DAS control system for one seismic survey or about one day.

The DAS control system controls the seismic survey and records the data received from the sensing cable 2 in the memory.

The instrument float 3 comprises a radio signal receiver which can receive a radio signal from a vessel instructing the DAS control system to begin a seismic survey.

The instrument float 3 is designed such that it will float on the sea surface 21.

The instrument float 3 is connected to a main anchor 6 via the riser cable 8. The riser cable 8 also connects to the sensing cable 2 and allows seismic (optical) signals to be passed from the sensing cable 2 to the instrument float 3.

The riser cable 8, as well as being able and arranged to transmit optical signals from the sensing cable 2 to the instrument float 3, also provides a mooring means for the instrument float 3. As such, the riser cable 8 comprises a signal-transmitting fibre-optic cable with a waterproof coating and a mooring cable such as a rope or chain. Thus, a signal-transmitting cable and a mooring cable are provided in (or in the form of) a single riser cable 8.

In one embodiment, the signal-transmitting cable is threaded through the mooring cable (e.g. inside an outer casing). In another embodiment, the signal-transmitting cable is threaded through apertures provided on the mooring cable at a plurality of locations along the length of the mooring cable.

In an alternative embodiment, a mooring cable for the instrument float is provided separately to (i.e. not attached or connected to) the signal-transmitting cable.

In either case, the mooring cable is stronger than the signal-transmitting cable.

In use, the mooring cable is arranged such that it experiences a greater load or strain than the signal-transmitting cable, i.e. it is arranged to prevent the signal-transmitting cable from experiencing any potentially damaging loads or strains.

The riser cable 8 is stronger than the sensing cable 2. This is because, when in use, it has to withstand greater forces, e.g. tensile forces, than the sensing cable, which is arranged on the seabed.

The sensing cable 2 is connected to the riser cable 8 by splicing it to the signal-transmitting cable of the riser cable 8 at (or near) the bottom of the riser cable 8.

The main anchor 6 helps to keep both the instrument float 3 and the sensing cable 2 in a relatively fixed position (there may still of course be some movement due to currents, for example). Any suitable anchor 6 can be used. Both the riser cable 8 and the sensing cable 2 are connected to the main anchor 6.

In an embodiment, the main anchor 6 is a patent anchor and the sensing cable 2 and the riser cable 8 are connected to the main anchor 6 in close proximity to each other and in a location on an upper surface of the main anchor 6. Connecting the cables 2 and 8 to the main anchor 6 on an upper surface thereof can help to avoid shearing of either cable (particularly the less robust sensing cable 2) from the main anchor 6 if they rub, for example, on the sea bed. A connector is provided on the main anchor 6 for connecting the riser cable 8 (e.g. its mooring cable) to the main anchor 6. A further connector is also provided to connect the sensing cable 2 to the main anchor 6.

The connectors are arranged such that the riser cable 8 and the sensing cable 2 can be connected to the main anchor 6 in a movable/slidable manner. In other words, the riser cable 8 and the sensing cable 2 can still move, e.g. slide longitudinally, with respect to the main anchor 6 whilst being held at or close to the main anchor 6 by the connectors.

In order to achieve this, the connectors each comprise a guide in the form of one or more loops, channels or apertures through which the riser cable 8 or the sensing cable 2 can be threaded, thereby allowing the riser cable 8 or the sensing cable 2 to move longitudinally with respect to the main anchor 6 whilst still being connected to it.

The connectors (especially the connector for the sensing cable 2) comprise rounded and smooth edges, i.e. with no sharp edges, such that they will not cause damage to the riser cable or (particularly) the sensing cable 2 when connected to it. For similar reasons, the connectors are also formed of a relatively soft material such as rubber.

Two or more buoys 4 are also provided. These are attached to the sensing cable 2 via ropes or cords 7. The ropes or cords 7 are also attached to small anchors 5. Any suitable anchors 5 could be used. The ropes or cords provide simple mechanical attachment between the buoys 4 and the sensing cable 2 and anchors 5. They do not need to transmit any signals so any kind or rope or cord suitable for such connection can be used.

In alternative embodiments (not shown), for example where the geological structure is particularly large and cannot be covered by a single sensing cable 2, two or more sensing cables may be used. In some cases, these will be provided in a system corresponding to the system 1 described above, so that each sensing cable 2 is connected to a separate instrument float 3. In other cases, multiple sensing cables 2 could be attached to a common or shared instrument float 3.

In order to deploy the system 1, a vessel (not shown) brings the system 1 to the area in which it is intended to be installed (e.g. above the geological structure 20). When the vessel is located above (or close to above) the geological structure 20, the sensing cable 2 is spooled out, starting with its first, free end 2a. As the sensing cable 2 is spooled out, the sensing cable 2 sinks down to the seabed 22. The cable 2 is spooled out such that it lies over the geological structure 20 in a predetermined pattern or arrangement, curving around such that the geological structure 22 is covered substantially evenly with the sensing cable 2. The positioning of the sensing cable 2 does not have to be particularly accurate but it is simply important that good overall (even) coverage of the geological structure 22 should be provided.

The first end 2a of the sensing cable 2 is spooled out such that it lies just outside of the area of interest (over the geological structure 22). This bit of excess length of sensing cable 2 allows the sensing cable 2 to be oriented in the correct direction for the rest of the spooling operation.

The second end 2b of the sensing cable 2 is spooled out such that it is located in a relatively central location over the geological structure 22, or over a most important area to survey. This can provide the best signal-to-noise ratio for the most important area.

The buoys 4 and instrument float 3 (with their associated anchors 5, 6) are connected to the sensing cable 2 via the cords 7 and riser cable 8 as the sensing cable 2 is spooled out.

When the sensing cable 2 has been spooled out and is connected to the buoys 4 and instrument float 3, the vessel is no longer connected to the system 1 and is free to move around the sea surface.

The purpose of the additional buoys 4 and associated small anchors 5 is twofold.

First, the frictional force between the sensing cable 2 and the seabed increases exponentially with the continuous length of the sensing cable 2 being dragged along the seabed. The smaller buoys 4 effectively divide the sensing cable 2 into segments and allow the sensing cable 2 to be lifted off the seabed in these segments, thereby substantially reducing the peak tension in the sensing cable 2 during retrieval.

Secondly, in order to stabilise the sensing cable 2, a small anchor 5 located upstream can stabilise the lay, thereby reducing the need for compensating for a moving sensing cable 2 if currents grab hold of or act on the sensing cable 2.

Once the system 1 has been deployed, as described above, before a seismic survey can be performed, the position of the sensing cable 3 must be determined. This can be done using a standard technique of emitting a seismic wave from a seismic source located on the vessel and measuring the first direct arrival. Synchronising the seismic source and varying the instrument float 3 repetition frequency can allow for “tricks” to be performed when only timing the first arrival, thereby effectively allowing the upper frequency limit of the instrumentation with a long cable to be circumvented for positioning purposes. If a spurious signal of a direct arrival from an area of little interest arrives it can essentially be subtracted from a total response to leave the main or wanted response after being identified at a lower pulse repetition frequency of the laser. Shifting the timing essentially shifts the position of the spurious signals, so e.g. a timing can be done so that the high frequency shallow seismic survey can be performed at a higher upper frequency than the total length of the cable would otherwise dictate. The rule of thumb in DAS surveys is to only use a pulse repetition rate as low as the total roundtrip time for the optical signal in the fibre. This would be a trick to not have to reposition the seabed array to achieve also a high frequency survey close to the seismic source, particularly in shallower water.

Such a method as described above can allow the position of the sensing cable 2 to be determined with a resolution of approximately 1-2 m of cable length, which is substantially better than most existing systems.

A seismic survey can be initiated by sending a radio signal from the vessel to the instrument float 3, signalling to start a seismic survey. On receipt of this signal, the battery on the instrument float 3 powers the instrumentation on the float to record the signals sensed in the sensing cable 2 and transmitted via the riser cable 8 to the instrument float 3.

To perform the seismic survey, the vessel travels around, e.g. criss-crossing, over the geological structure 20 and sensing cable 2, emitting seismic waves from a seismic source (e.g. in a standard way as is known in the art).

The seismic source and the instrument float 3 electronics repetition frequency are synchronised using a recorded GPS clock signal and are time shifted in the seismic processing.

Seismic data collected during the survey is stored in the memory on the instrument float 3. After the survey has been performed, the/a vessel collects the memory from the float 3 and takes it for further storage, processing and/or analysis.

During the survey, a gauge length of the order of 5-10 m is typically a good compromise for improving signal-to-noise ratio for weaker signals. In effect the gauge length can be compared to a conventional hydrophone group, only the whole cable over this length is contributing not only discrete hydrophones.

Once a survey has been performed, the system 1 can be recovered as will now be described.

In one embodiment, the whole sensing cable 2 is disconnected and left in the sea. Use of biodegradable intermediate and outer layers 2b and 2c can be useful in such cases. In such cases, the instrument float and buoys 4 could still be collected, optionally with the anchors 5, 6, cord 7 and/or riser cable 8.

In another embodiment, the sensing cable 2 could be spooled back in (in the opposite way to which was deployed initially, and possibly using the same spooling means. The spooled-in sensing cable 2 could then be taken away for appropriate disposal. If the sensing cable 2 snapped or broke during such a spooling-in operation, then any broken-off part of the sensing cable 2, which it was then not possible to spool in, could be left in the sea (e.g. to biodegrade, if possible).

In a further embodiment, the instrument float 3 and buoys 4 could be used to retrieve the sensing cable 2 by gathering up the instrument float 3 and buoys 4 (which are connected to the sensing cable 2 via the riser cable 8 and cords 7), e.g. in a similar way to which crab pods on a line are retrieved. The large arrow 30 in FIG. 3 indicates the direction in which a vessel could travel to retrieve first the instrument float 3 and then the buoys 4, thereby gathering up the sensing cable 2 with them.

Alternatively, the buoys 4 could be retrieved (and hence the sensing cable 2) with a trawl gate system 40 such as illustrated in FIG. 4. In this system 40, a trawl gate 42 connected to a vessel 43 with cables 44 via a grapping device 41, and an underwater slack line 45, allows the instrument float 3 and buoys 4 (and the sensing cable 2 to which they are connected) to be captured in the grappling device 41.

I claim:

1. A distributed acoustic sensing system for acquiring seismic data, the system comprising:
a. a fibre optic sensing cable for sensing seismic waves, the fibre optic sensing cable being suitable for use on the seabed; and
b. an instrument floating structure comprising at least some instrumentation for use in the acquisition of seismic data, the instrument floating structure being connectable or connected to the fibre optic sensing cable via a riser cable;
wherein the fibre optic sensing cable is a continuous unbranched cable.

2. A system as claimed in claim 1, wherein the sensing cable comprises:
c. a sensing part; and
d. one or more protective layers arranged around the sensing part.

3. A system as claimed in claim 2, wherein the sensing part comprises a glass fibre part, the glass fibre part preferably consisting of a single glass fibre strand.

4. A system as claimed in claim 2, wherein the protective layer has a lower elastic modulus than the sensing part.

5. A system as claimed in claim 2, wherein the protective layer:
e. comprises a silicone layer; and/or
f. adheres or is adhered to the sensing part.

6. A system as claimed in claim 2, wherein the one or more protective layers comprise an inner protective layer and an outer protective layer, the inner protective layer being arranged between the sensing part and the outer protective layer, and the outer layer:
g. has greater tensile strength and/or weight and/or density than the sensing part and/or the inner protective layer; and/or
h. is made of high density polypropylene or high density polyethylene.

7. A system as claimed in claim 2, wherein one or more of the one or more protective layers and/or an outer layer is/are:
i. biodegradable; and/or
j. arranged to prevent water from contacting the sensing part when arranged underwater for at least one day or at least one week; and/or
k. arranged to biodegrade or decompose when underwater for longer than one day or one week.

8. A system as claimed in claim 1, wherein the sensing cable has sufficient density that it will sink down to a seabed.

9. A system as claimed in claim 1, wherein the at least some instrumentation for use in the acquisition of seismic data comprises a receiver for receiving a signal to begin a seismic survey.

10. A system as claimed in claim 1, wherein the instrument floating structure is connected to an anchor.

11. A system as claimed in claim 1, wherein the riser cable is suitable for transmitting optical signals and/or comprises a mooring part or cable.

12. A system as claimed in claim 1, the system further comprising one or more buoys, the buoys being connected to the sensing cable via one or more connection means.

13. A distributed acoustic sensing system for acquiring seismic data, the system comprising:
l. a single sensing cable for sensing seismic waves, the sensing cable being suitable for use on the seabed; and
m. an instrument floating structure comprising at least some instrumentation for use in the acquisition of seismic data, the instrument floating structure being connectable or connected to the sensing cable via a riser cable;
wherein the sensing cable comprises:
a sensing part comprising a glass fibre part; and
one or more protective layers arranged around the sensing part.

14. A method of deploying a distributed acoustic sensing system for acquiring seismic data, the system being according to claim 1, the method comprising:
n. deploying the sensing cable from a vessel; and
o. connecting the instrument floating structure via the riser cable to the sensing cable.

15. A method as claimed in claim 14, wherein the system is deployed such that the sensing cable is arranged in such a way that signal interference is minimised or avoided.

16. A method as claimed in claim 14, wherein one or more buoys are connected to the sensing cable, preferably as the sensing cable is deployed.

17. A method as claimed in claim 14, further comprising determining the position of the deployed sensing cable.

18. A method of acquiring seismic data related to a subsea geological structure, the method comprising using a distributed acoustic sensing system as defined in claim 1, the method comprising:
p. emitting seismic waves and/or pulses from a seismic source; and
q. detecting reflected seismic waves and/or pulses with the sensing cable.

19. A method as claimed in claim 18, the method further comprising recording seismic data representing the detected seismic waves with or at the instrument floating structure.

20. A method as claimed in claim 18, the method further comprising receiving a signal at the instrument floating structure, the signal comprising instructions to start a seismic survey.

21. A method of recovering a distributed acoustic sensing system as defined in claim 1, the method comprising gathering or retrieving the instrument floating structure and/or one or more buoys connected to the sensing cable via one or more connection means.
